(19) United States
(12) Patent Application Publication
(10) Pub. No.: US 2008/0098245 A1
(43) Pub. Date: Apr. 24, 2008

(54) Power management system and method

(75) Inventors: Michael T. Hogan, Beecroft (AU); Thomas McDermott, Thomleigh (AU)

Correspondence Address: BSTZ/G2 MICROSYSTEMS, INC., 12400 Wilshire Boulevard, Seventh Floor, Los Angeles, CA, 90025-1030, US

(73) Assignee: G2 Microsystems, Inc.

(21) Appl. No.: 11/638,998

(22) Filed: Dec. 13, 2006

Related U.S. Application Data
(60) Provisional application No. 60/785,009, filed on Mar. 22, 2006.

(51) Int. Cl. G06F 1/00

(52) U.S. Cl. 713/323

(57) ABSTRACT

Power management for a computing device is described based on idle thread code execution and other conditions. In one example, a controller is operated at a first power state. Then the controller is transitioned from the first power state to a second lower power state after it starts executing idle thread code. As an additional optional feature it may be determined whether any one or more of a plurality of conditions is true and the controller may be transitioned from the first power state to the second power state if one or more of the plurality of conditions is true.

### CROSS-REFERENCE TO RELATED APPLICATIONS

This non-provisional application claims the benefit of earlier filed provisional application 60/785,009, filed Mar. 22, 2006, and entitled “Power Management System and Method”, the entirety of which is hereby incorporated by reference.

### BACKGROUND

1. Field

This description relates generally to a power management system for a computing device, and in particular to managing power based on idle thread code execution and other conditions.

2. Related Art

Many computing devices use electrical energy from a limited source of power resident with the device, such as a battery. Conserving power in devices with a finite amount of power is a paramount concern. Attempts are being made to extend the ability of these devices to operate without exhausting their supply of power. Semi-passive and active Radio Frequency Identification (RFID) tags are examples of one type of computing device with limited sources of power. Such tags rely on battery power to energize their Integrated Circuits (ICs) when performing tasks such as generating an outgoing signal or processing an incoming signal. To avoid depleting their battery power, most RFID tags attempt to conserve energy when it is not needed, such as when not communicating with other devices or performing other tasks.

Accordingly, during periods of activity, the tag operates in a first power state (highest power state). Then during periods of inactivity, it is common for an RFID tag to operate in a second power state (lowest-power state) in which a minimal amount of electrical energy is consumed, often referred to as a hibernation or sleep mode. On the other hand, when an event occurs prompting the RFID tag to perform a task, such as communicating with (sending data to or receiving data from) another device, the RFID tag switches from the second power state to the first power state in which an increased amount of electrical energy is used to power its Integrated Circuits (ICs) and other components. This first power state (high-power state) is often referred to as an active or awake mode of operation

Knowing when to transition from the high-power state to the lowest-power state is often an inefficient process. The process is often dependent upon which application is controlling operation of the computer device, and how well it was programmed to instruct the computer device with respect to when it is appropriate to power-down. The application may not have been programmed in a manner which optimizes power consumption for the computer device. As a result, many computer devices are late to, or fail to, take advantage of opportunities in which it is possible to transition from a high-power state (such as active mode of operation) to a state of operation in which less power is consumed.

### SUMMARY

Power management for a computing device is described based on idle thread code execution and other conditions. In one example, a controller is operated at a first power state. Then the controller is transitioned from the first power state to a second lower power state after it starts executing idle thread code. As an additional optional feature it may be determined whether any one or more of a plurality of conditions is true and the controller may be transitioned from the first power state to the second power state if one or more of the plurality of conditions is true.

### BRIEF DESCRIPTION OF THE DRAWINGS

The detailed description is explained with reference to the accompanying figures. In the figures, the left-most digit of a reference number identifies the figure in which the reference number first appears. The drawings should not be taken to be limiting, but are for explanation and understanding only.

FIG. 1 illustrates a computing device within which the present invention can be either fully or partially implemented according to one embodiment of the invention.

FIG. 2 shows a portion of a controller (system) configured to identify when the CPU has stalled and then determine a manner to reduce power consumption of a computer device based on examination of variable conditions according to one embodiment of the invention.

FIG. 3 illustrates an example method for conserving power in a computing device, such as the device shown in FIG. 1 according to one embodiment of the invention.

### DETAILED DESCRIPTION

Described herein are exemplary embodiments of power management systems and methods for reducing power consumption of a computer device. The various techniques in accordance with the present invention may be implemented in hardware, firmware, software, and/or a combination of the aforementioned. The power management systems and methods reduce power consumption by inferring when it is possible to power-down one or more hardware portions of the computer device when certain code (for example, the idle thread code) is executed by at least one Central Processing Unit (CPU) of the computer device. Accordingly, described herein is a power management framework that facilitates a mode of operation in which a computer device expends as little energy as possible. This is accomplished by monitoring thread behavior (idle thread code) to decide whether to power-down the computer device or shut-down certain portions of the computer device, when appropriate, based on operational conditions.

The following description sets forth power management techniques that reduce power consumption of a computing device. The various techniques in accordance with the present invention may be implemented in hardware, firmware, software, and/or a combination of the aforementioned. The power management techniques reduce power consumption by inferring when it is possible to power-down one or more hardware portions of the computer device when certain code (e.g., the idle thread code) is executed by at least one Central Processing Unit (CPU) of the computer device.

In one example implementation, the techniques are generally implemented as part of code for controlling operation of a CPU of a computer device, such as firmware or operating system code. In various embodiments, one or more portions of the computer device can be powered-down from a high-power state when idle thread code is executed by the CPU. The computer device can also transition from a high-power state to one of a plurality of lower-power states or the lowest-power state, based at least in part, upon an outcome of a determination on whether any one of one or more conditions is true. That is, the extent to which the computer device transitions from a high-power state to one of a plurality of lower-power states or the lowest-power state, is based at least in part, upon the outcome of the determination.

For example, if a determination is made that an application has set a condition (such as a flag) indicating to the computer device that it is not to enter the lowest power state, then the computer device may transition from the high-power state to one of the lower-power states by only turning-off the clock to the CPU (also referred to as dozing). On the other hand, if a determination is made that no conditions are true which would, for example, prevent the computer device from transitioning from the high-power state to the lowest-power state, then the computer device may transition from the high-power state to the lowest-power state. The quantity and types of conditions may vary and be dependent upon the type of computer device.

Example Computing Device

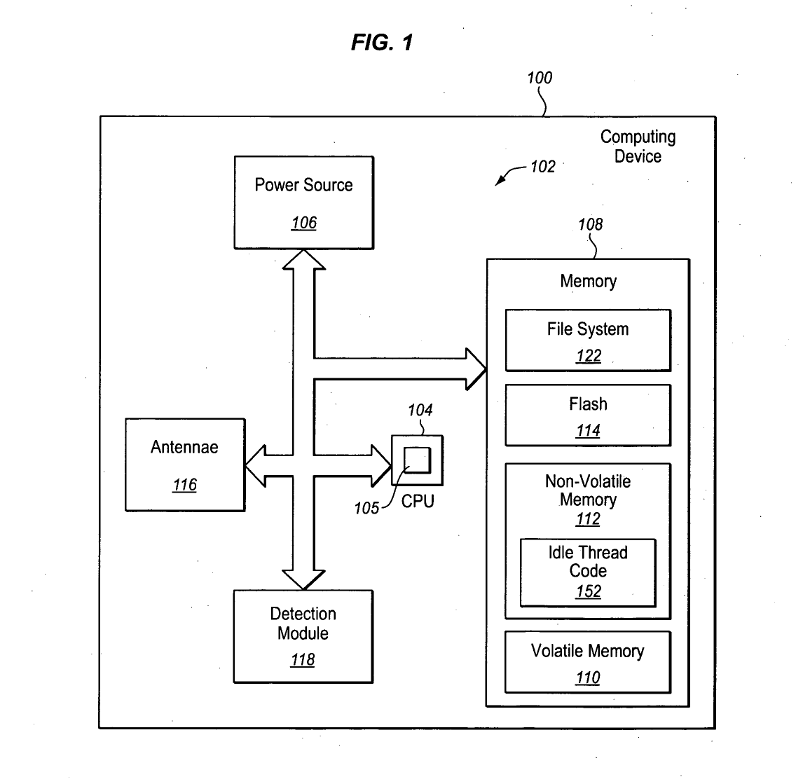

FIG. 1 illustrates a computing device 100 within which an example of the present invention can be either fully or partially implemented. In one possible embodiment, computing device 100 is implemented as a Radio Frequency Identification (RFID) tag. Although some of the discussion below will focus on an RFID tag as an example, embodiments of the present invention are not limited to RFID tags, and may be used with other computing devices 100. For example, computing device 100 may be other general or special purpose computing devices, such as, but not limited to, wireless communication devices (e.g., mobile phones), music players, multimedia recorders and players, personal digital assistants, mobile gaming systems, the combination of any of the above example devices, and other suitable intelligent devices.

Computing device 100 includes an embedded controller 102 including at least one Central Processing Unit (CPU) 104 having one or more processors 105, a limited power source 106, such as a battery, and memory 108. Memory 108 may include volatile memory (e.g., RAM) 110 and/or non-volatile memory (e.g., ROM) 112. In some implementations, volatile memory 110 is used as part of computing device's cache, permitting application code and/or data to be accessed quickly and executed by CPU 104. Memory 108 may also include non-volatile memory in the form of flash memory 114. It is also possible for other memory mediums (not shown) having various physical properties to be included as part of computing device 100. It is noted that memory 108 is also referred to herein as processor-readable media in the form of volatile memory, and/or non-volatile memory.

A file system 122 may reside as a component in the form of computer-executable instructions and/or logic within memory 108, that when executed serves as a logical interface between code stored in flash 114 and other storage media. File system 122 is generally responsible for performing transactions on behalf of code stored in ROM or one or more applications. File system 122 may also assist in storing, retrieving, organizing files, and performing other related tasks associated with code and/or data. That is, file system 122 has the ability to read, write, erase, and manage files (applications, etc.).

Computing device 100 may also include one or more antennae 116 to transmit and/or receive radio frequencies and other energy wirelessly. Additionally, computing device 100 may include a detection module 118 configured to receive and detect electrical and/or magnetic energy or other events which, as shall be explained, cause computing device 100 to transition from a first power-state to a second power-state or vice versa. Detection module 118 may be implemented as hardware and optionally software and/or firmware that causes computing device 100 to detect different types of power-state transition events. A power-state transition event is typically one of a plurality of different events which causes computing device 100 to transition from one power-state to another power-state. Examples of such events include, but are not limited to, expiration of a timer (not shown), a radio frequency request for an electronic product code such as from a reader (not shown), receipt of magnetic energy such as from a choke point (not shown), detection of a current, a watchdog timer event, and any series of succeeding events within a specified period of time.

Detection module 118 is typically connected in some fashion to controller 102 (processor 104) and memory 108. Detection module 118 may record a power-state transition event when it is detected by the detection module 118. For example, when detection module 118 is at least partially implemented in hardware, receipt of certain electrical energy such as a particular radio frequency may cause detection module 118 to send one or more signals to controller 102, which in turn causes controller 102 to transition from one power-state (e.g., sleep/hibernation mode, or dozing mode) to another power-state such as a high-power state (e.g. awake mode).

When awoken in a high-power state, power is supplied to CPU 104 to enable it to execute code. When first awoken, CPU 104 typically executes firmware code or other basic input/output system (BIOS) code to enable startup, often referred to as boot-up. Once boot-up is complete, typically CPU 104 begins executing code in the form of one or more program applications which is loaded into volatile memory 110 to enable quick access by processor 104.

During any period when CPU 104 is idle, such as when it is has completed executing code associated with an application program, CPU 104 may execute one or more idle threads, referred to as idle thread code. Idle thread code is a set of code executed by CPU 104 when it is not executing application code and is looping or waiting to execute application program code. For example, CPU 104 may have completed processing code associated with application programs and, in the absence of any further application program input, CPU 104 executes idle thread code. The reason why CPU 104 may have launched the idle thread code varies as is appreciated by those skilled in art. As shall be explained in more detail, execution of the idle thread prompts CPU 104 to transition from the high-power state to one or more lower-power states or the lowest-power state.

In one embodiment, idle thread code 152 is stored in non-volatile memory 112, such as ROM, in the form of firmware. Idle thread code 152 may also be part of the operating system or reside as a separate set of code accessible by CPU 104. In any embodiment, Idle thread code 152 may contain instructions which enable CPU 104 to determine whether it is possible to transition from a high-power state to one or more lower-power states, to conserve power resources. The determination may be made based on one or more operating parameters (i.e., state of operation), referred to as conditions of computing device 100.

Example Power Conservation

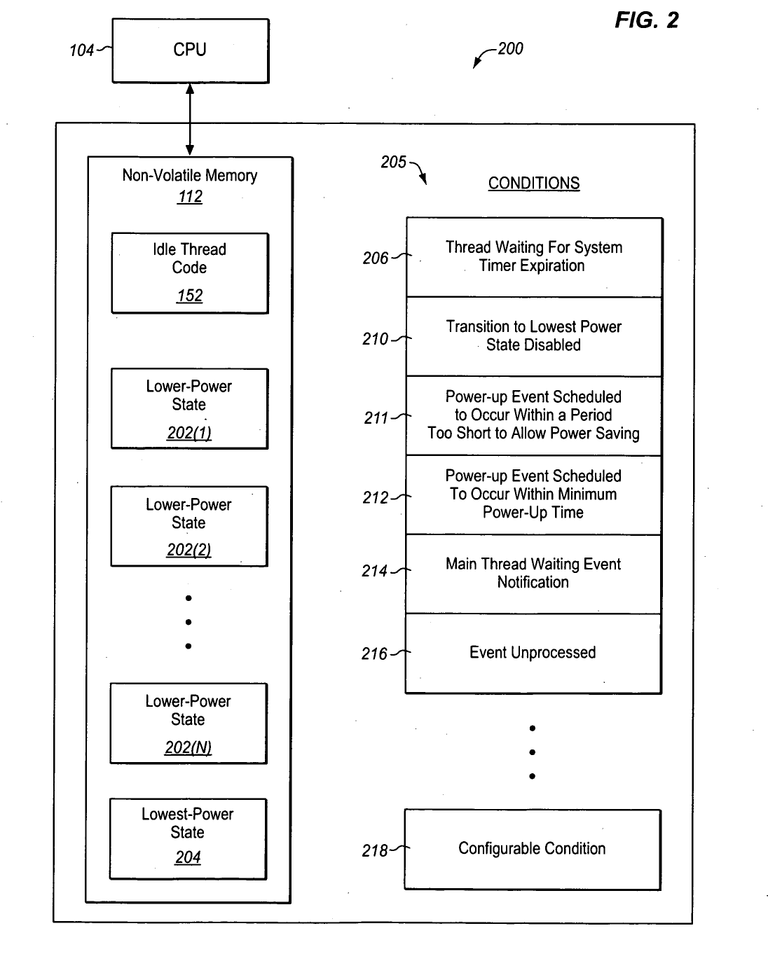

FIG. 2 shows a portion 200 of controller 102 (system) configured to identify when CPU 104 has stalled and then determine a manner to reduce power consumption of computing device 100 based on examination of logical variable conditions 205. In one embodiment, when CPU 104 stalls, because it is waiting for additional input 108 (FIG. 1), CPU 104 executes idle thread code 152, which prompts CPU 104 to automatically determine whether it is possible to power-down, and in what fashion. That is, the mechanism for identifying a logically enabled state or condition of the central processing unit is included in the idle thread code 152 when executed by CPU 104 so that ICs, or a portion of a single IC, can be powered-down when the CPU is executing idle thread 152.

For instance, suppose CPU 104 is executing idle thread code 152 as a result of a processing stall. Idle thread code 152 prompts CPU 104 to determine whether any one of one or more logical conditions 205 is true. For example, in one embodiment, CPU 104 will check whether any one of several logical conditions 205 are true, such as, but not limited to, (i) whether a thread is waiting for a system timer to expire (block 206); (ii) whether any event notifications are unprocessed (block 216); (iii) whether a condition preventing a transition to the lowest power state is true (block 210); (iv) whether an event is scheduled to occur within a minimum period of time needed to transition from the lowest-power state to the high-power state (block 212); (v) whether a main thread is doing something other than waiting for an event notification (block 214); (vi) whether an event is scheduled to occur within a period of time such that transitioning to the lowest-power state and returning to the high-power state will not result in an overall power saving (block 211); and other configurable conditions (block 218) as those skilled in the art would appreciate having the benefit of this disclosure. For example, whether the battery source 106 (FIG. 1) is reading below a certain threshold

If any of the aforementioned logical conditions 205 are true, idle thread code 152 (or other code prompted by CPU) executed by controller 102 instructs one or more portions of computer device 100 to transition from a high-power state to one of a plurality of lower-power states 202(1), 202(2), . . . 202(N), or the lowest-power state 204, based at least in part, upon an outcome of such determination. Each block representing lower-power states 202 or the lowest power-state 204 are logical representations of code instructing CPU 104 to perform one or more operations to cause computer device 100 to reduce power consumption by powering-down ICs, or portions of a single IC, associated with one or more portions of computer device 100.

For example, suppose a thread is waiting for system timer expiration (block 206), then it may be possible to power-down at least a portion of CPU 104 until expiration of such a timer. One of the lower-power states, referred to generally as reference number 202 may be selected, which corresponds to this condition, such as turning-off a portion of the CPU 104 (or other physical devices). For example, a CPU may be placed in powered-down mode of operation (also commonly referred to as dozed, suspended, temporarily halted, etc.), and the CPU will stop executing instructions until power is resumed. Other devices or portions of the CPU may also be powered-down when transitioning from the high-power state to the lower-power state.

A high-power state or higher-power state suggests an active mode of operation in which the computing device has energized more ICs (or more portions of a single IC) or more devices and is consuming more power when compared to one or more of the lower-power states or the lowest-power state. On the other hand a low power state or lower-power state 202 suggests a mode of operation in which select portions of the computing device are consuming less, or a minimal amount, of electrical energy. For example, a CPU may be placed in a powered-down mode of operation (also commonly referred to as dozed, suspended, temporarily halted, etc.), so that the CPU will stop executing instructions until power is resumed. Other devices or portions of the CPU may also be powered-down when transitioning from the high-power state to the lower-power state. The lowest-power state 204 suggests a mode of operation in which a minimal amount of electrical energy is consumed, often referred to as a hibernation or sleep mode.

With respect to low-power state operation, it will be appreciated by those skilled in the art and having the benefit of this disclosure, that reductions in power consumption in integrated circuits may be achieved in a variety of ways, including but not limited to, reducing the power supply voltage, reducing clock frequency, reducing leakage current (for example by modifying a substrate or well voltage), and combinations of the foregoing.

In certain circumstances, if an event is scheduled to occur within a minimum period of time needed to transition from a high-power state to one of the plurality of lower-power states 202 or the lowest-power state 204 (see logical block 214), it may not be prudent to power down a physical device or a portion thereof. In such a situation, the powering-down feature may be counterproductive; because computing device 100 may consume more power than if computing device 100 simply remained in a high-power state.

It is noted that certain program applications may have the ability to set a flag or condition (210) which instructs CPU 104 not to select the lowest-power state 204 (that is, not to power-down). For example, suppose a cell phone (or other computer device) is unable to temporarily wirelessly communicate with a service point, due to poor signal reception such as when in a tunnel. Rather than power-down the phone (computing device 100), application code may be configured to enable a flag which instructs the cell phone not to power-down if such a condition is present.

In certain situations, it may be possible that no conditions 205 are true. In other words, an application program may have been fully executed and there is no need for computing device 100 to remain in a high-power state. Accordingly, based on the outcome of such a determination by idle thread code 152, the lowest-power state 204 is selected and computer device 100 transitions to this power-state accordingly.

An application program interface (API) code (not shown) may be called by idle thread code 152 to communicate with the appropriate devices in which it is desired to power-down.

Example Method of Operation

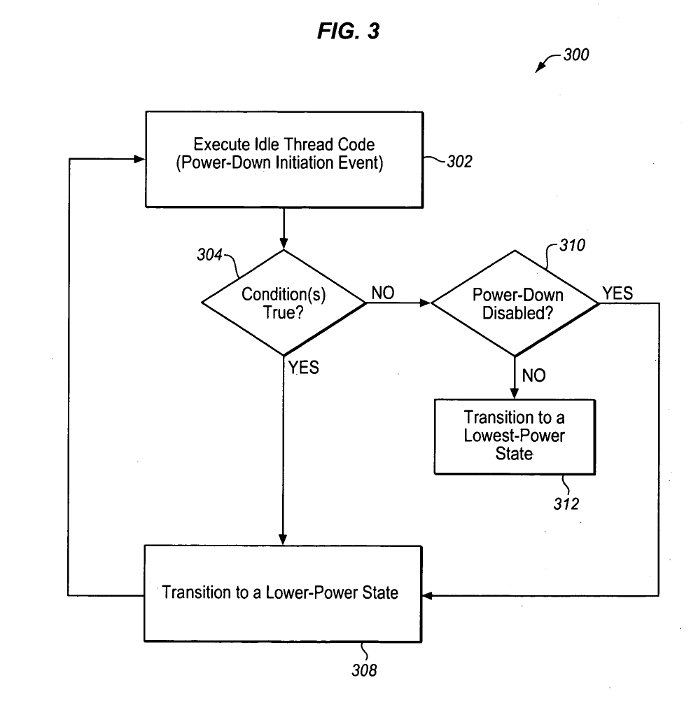

FIG. 3 illustrates an example method 300 for conserving power in a computing device, such as device 100 of FIG. 1. Method 300 includes blocks 302, 304, 306, 308, 310, and 312 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof. Additionally, although each module in FIG. 3 is shown as a single block, it is understood that when actually implemented in the form of computer-executable instructions, logic, firmware, and/or hardware, that the functionality described with reference to it may not exist as a separate identifiable block.

Referring to FIG. 3, in block 302 idle thread code is executed. For example, in one embodiment idle thread code 152 (FIGS. 1 and 2) from memory 108 is executed by CPU 104 (FIGS. 1 and 2), which automatically prompts a determination of whether to transition to a lower-power state 202, 204. Idle thread code 152 is typically executed when CPU 104 has stalled or completed executing instructions associated with an application program. It is possible that other instructions or flags could prompt initiation of method 300.

In block 304, a determination is made whether any logical conditions which should prevent the system from entering the lowest power state 204 are true. For example, in one embodiment, CPU 104 (FIGS. 1 and 2) will check whether any one of several logical conditions 205 are true, such as, but not limited to, (i) whether a thread is waiting for a system timer to expire (block 206); (ii) whether any event notifications are unprocessed (block 216); (iii) whether a condition preventing a transition to the lowest power state is true (block 210); (iv) whether an event is scheduled to occur within a minimum period of time needed to transition from a high-power state to one of the plurality of lower-power states or the lowest-power state (block 212); (v) whether a thread is waiting for an event notification (block 214), and other configurable conditions (block 218) as those skilled in the art would appreciate having the benefit of this disclosure. For example, whether the battery source 106 (FIG. 1) is reading below a certain threshold.

If any of the logical conditions are true in block 304, then method 300 proceeds to block 308 so that method 300 can transition from the high-power state to a lower-power state.

In block 308, computing device 100 transitions from a high-power state to a lower-power state. For example, in one embodiment, if any of the aforementioned logical conditions 205 are true from block 304, idle thread code 152 (or other code prompted by CPU 104) instructs one or more portions of computing device 100 to transition from a high-power state to one of a plurality of lower-power states 202(1), 202(2), . . . , 202(N), based at least in part, upon an outcome of such determination. The power-state actually selected for transition may correspond to the lowest possible state permissible given the condition, i.e., which would yield the greatest possible power savings.

If all of the logical conditions are not true in block 304, then method 300 proceeds to block 310. In block 310, if for any reason the power-down feature has been disabled, then method 308 will transition from high-power state to the lower-power state as indicated by the YES branch of block 310. However, if the power-down feature has not been disabled, then method 300 proceeds to block 312, according to the NO branch of block 310.

In block 312, computing device 100 transitions to the lowest-power state. For example, in one embodiment, an application program may have been fully executed. Accordingly, based on the outcome of the determination from block 304, idle thread code 152, selects the lowest-power state 204 for computing device 100 to transition.

Again, it is noted that the term high-power does not necessarily mean drawing high power, but may also refer to an active execution state in which the CPU is drawing power to execute code. With respect to block 304, there may be logical combinations of a base set of conditions, as well as threshold filters used for the conditions based on the amount of remaining battery charge. For example, some conditions may not be checked if the reserve battery power is measured below a configurable threshold.

It should also be noted, that allowing power-down functionality to be associated with idle thread code 152 allows programmers who write applications to write such applications with little concern or effort devoted to hardware power-down events. That is, the programmer does not need to be intimately acquainted with the details of the hardware's power saving features so more time can be devoted to ensuring correctness of the application in other respects. Thus, the systems and methods of the invention are intended to be transparent to program applications.

As described above, a power management technique may be used to reduce power consumption of a computer device by inferring when it is possible to power-down one or more hardware portions of the computer device when certain code (e.g., the idle thread code) is executed by a Central Processing Unit (CPU) of the computer device. The extent to which the computer device transitions from a high-power state to one of a plurality of lower-power states or the lowest power state, is based at least in part, upon an outcome of a determination on whether any one of one or more conditions is true.

References herein to “one embodiment”, “an embodiment”, or the like do not necessarily all refer to the same embodiment. Any particular features, structures, operations, or characteristics described in connection with any particular embodiment, may be included in at least one embodiment of the present invention and may also be included in other embodiments. Furthermore, various particular features, structures, operations, or characteristics may be combined in any suitable manner in one or more embodiments.

The terms, integrated circuit (IC), semiconductor device, monolithic device, microelectronic device, and chip are often used interchangeably in the field of electronics generally. The present invention is applicable to all the above as they are generally understood in the field.

A lesser or more complex computing device, embedded controller, processor, detection module and memory structure may be used than those shown and described herein. The power supply may come from a battery, from a mains-connected voltage converter, or from a variety of other generation or storage devices and combinations of these. Therefore, the configurations may vary from implementation to implementation depending upon numerous factors, such as price constraints, performance requirements, technological improvements, or other circumstances. Embodiments of the invention may also be applied to other types of computing devices with and without radio interfaces or computers. Different types of transceivers, instruction structures and protocols may be used than those shown and described herein.

In the description above, numerous specific details are set forth. However, it is understood that embodiments of the invention may be practiced without these specific details. For example, well-known equivalent circuits, components, assemblies and configurations may be substituted in place of those described herein, and similarly, well-known equivalent techniques, process, and protocols may be substituted in place of the particular techniques disclosed. In other instances, well-known circuits, structures and techniques have not been shown in detail to avoid obscuring the understanding of this description.

The embodiments described herein are to be considered in all respects only as examples and not as restrictions. The scope of the invention is, therefore, indicated by the claims below rather than by the description above. All changes which come within the meaning and range of equivalency of the claims are to be embraced as within their scope.

What is claimed is:

1. A method comprising:
operating a controller at a first power state;
executing idle thread code in the processor during the first power state;
transitioning the controller from the first power state to a second lower power state after the start of executing idle thread code.

2. The method of claim 1, further comprising:
determining whether any one or more of a plurality of conditions is true;
transitioning from the first power state to the second power state if one or more of the plurality of conditions is true.

3. The method of claim 2, wherein determining whether any one of one or more conditions is true includes determining at least one of:
(i) whether a thread is waiting for a system timer to expire;
(ii) whether any event notifications are unprocessed;
(iii) whether an event is scheduled to occur within a minimum period of time; and
(iv) whether application code is waiting for an event notification.

4. The method of claim 2, further comprising transitioning to a lowest-power state upon a determination that none of the plurality of conditions is true.

5. The method of claim 2, wherein transitioning comprises transitioning to a lowest possible power state permissible given the conditions that are determined to be true.

6. The method of claim 2, further comprising determining whether a power down feature is disabled and wherein transitioning comprises transitioning to a second power state other than a power down state if the power down feature is disabled.

7. The method of claim 1, wherein transitioning from the first power state to the second power state includes powering down at least a portion of a processing unit of the controller.

8. The method of claim 1, wherein transitioning from the high-power state to one of the plurality of lower-power states includes powering down at least a portion of a central processing unit and at least a memory device of the controller.

9. The method of claim 1, wherein transitioning from the first power state to the second power state, includes powering-down each central processing unit, and memory device of the controller.

10. A machine-readable medium comprising instructions that, when executed by the machine, cause the machine to perform operations comprising:
operating a controller at a first power state;
executing idle thread code in the machine during the first power state;
transitioning the machine from the first power state to a second lower power state after the start of executing idle thread code.

11. The medium of claim 10, wherein the operations further comprise:
determining whether any one or more of a plurality of conditions is true;
transitioning from the first power state to the second power state if one or more of the plurality of conditions is true.

12. The medium of claim 11, wherein the operations further comprise transitioning to a lowest-power state upon a determination that none of the plurality of conditions is true.

13. The medium of claim 11, wherein the operations further comprise determining whether a power down feature is disabled and wherein transitioning comprises transitioning to a second power state other than a power down state if the power down feature is disabled.

14. A system comprising:
a memory to supply idle thread code; and
a processor to execute the supplied idle thread code when the system is in a first power state;
wherein the processor transitions the system to a second lower power state after the processor starts executing the idle thread code.

15. The system of claim 14, further comprising a detection module to detect whether any one of a plurality of conditions are true and to supply the determination to the processor, wherein the processor transitions the system to the second lower power state based, in part, on the supplied determination.

16. The system of claim 15, wherein the processor transitions the system from the first power state to the second power state upon a determination that none of the conditions is true.

17. The system of claim 15, wherein the processor transitions the system from the first power state to one of a plurality of lower-power states upon a determination that any one of the plurality of conditions is true.

18. The system of claim 15, further comprising an antenna and wherein the detection module is coupled to the antenna to transition the processor from the second power state when radio energy is received by the antenna.

19. The system of claim 15, further comprising a battery and wherein one of the plurality of conditions comprises a low charge state of the battery.

20. The system of claim 14, wherein the idle thread code is part of an operating system for the system.
